(19) United States
(12) Patent Application Publication
(10) Pub. No.: US 2011/0262880 A1
(43) Pub. Date: Oct. 27, 2011

(54) METHOD FOR FILTERING AND TREATING DENTAL SOLID WASTE

(76) Inventor: Charles McCary, Huntsville, AL (US)

(21) Appl. No.: 12/909,939

(22) Filed: Oct. 22, 2010

Related U.S. Application Data
(63) Continuation-in-part of application No. 12/136,151, filed on Jun. 10, 2008.
Application No. 12/136,151 is a continuation-in-part of application No. 11/111,618, filed on Apr. 21, 2005, now abandoned.
(60) Provisional application No. 60/564,334, filed on Apr. 22, 2004.

(51) Int. Cl. A61C 17/08; B01D 29/90

(52) U.S. Cl. 433/92; 210/768; 210/808

(57) ABSTRACT

The present application discloses a method of separating solid dental waste from liquid dental waste including capturing the solid dental waste in a permanently filtration unit while the liquid dental waste passes through the filtration unit, transferring the filtration unit to a central storage container; storing the central container until the central container is shipped to a handling facility; and separating the solid dental waste from the filtration unit.

### CROSS-REFERENCE TO RELATED APPLICATIONS

This application is a continuation-in-part of U.S. patent application Ser. No. 12/136,151 filed on Jun. 6, 2008, entitled “Apparatus for Filtering Dental Solid Waste,” which in turn was continuation-in-part of U.S. patent application Ser. No. 11/111,618, filed Apr. 21, 2005 entitled “Apparatus for Filtering Dental Solid Waste,” which claimed priority from U.S. Provisional Application No. 60/564,334 entitled “Apparatus for Filtering Dental Solid Waste” that was filed on Apr. 22, 2004.

### BACKGROUND OF INVENTION

1. Field of the Invention

The invention relates generally to medical devices. More specifically, the invention relates to an apparatus for filtering dental solid waste and a method of using same.

2. Background Art

When filings in teeth are replaced or removed, the composition of the filings is often a mixture of such materials as silver, mercury, copper, zinc, tin, palladium, etc. These materials, along with other solid or semi-solid debris, pose disposal problems for dental facilities since they may contain hazardous and possibly bio-hazardous material.

Such material is typically removed from the patient's mouth by a high volume evacuation (HVE) tip as shown in FIG. 1. The HVE tip 10 is attached to a tube 12 with a vacuum that draws both liquid and solid material from the patient's mouth. A first filtration canister 14 is located at the patient's chair to provide an initial filtration to remove solid debris. A second filtration trap 16 is located further along the line before the vacuum pump 18. After the vacuum pump, the filtered liquid in disposed in the sewer.

The filtration canister and the filtration trap are each periodically cleaned by hand. This typically involves removed the filtration screen from the canister or trap and cleaning off the filtered debris. This is an unpleasant, messy and potentially dangerous process since the person responsible for the cleaning is exposed to these materials. Additionally, the filtered materials such as mercury must be disposed of properly since they cannot simply be added to the sewer or trash.

### SUMMARY OF INVENTION

In some aspects, the invention relates to an apparatus for filtering dental solid waste, comprising: a high volume evacuation (HVE) tip with a first end that is connected to a suction line and a second end that is inserted in a patient's mouth to remove dental waste; and a filtration unit that is located between the first end of the HVE tip and the second end of the HVE tip, where the filtration unit retains solid dental waste within the HVE tip.

In other aspects, the invention relates to an apparatus for filtering dental solid waste, comprising: a high volume evacuation (HVE) tip with a first end that is connected to a suction line and a second end that is inserted in a patient's mouth to remove dental waste; and means for filtering and retaining dental solid waste within the HVE tip.

The present application discloses a method of separating solid dental waste from liquid dental waste including capturing the solid dental waste in a permanently filtration unit while the liquid dental waste passes through the filtration unit, transferring the filtration unit to a central storage container; storing the central container until the central container is shipped to a handling facility; and separating the solid dental waste from the filtration unit.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of a prior art filtration system for dental solid waste.

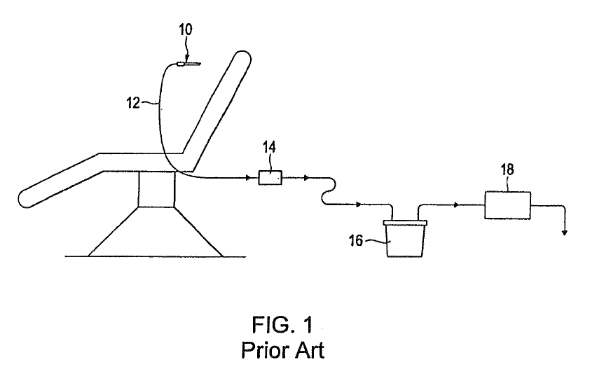

FIGS. 2a and 2b show perspective views of a High Volume Evacuation (HVE) tip both with and without a Saliva Ejector (SE) in accordance with one embodiment of the present invention.

FIGS. 3a-3c show top and cross-sectional views of a High Volume Evacuation (HVE) tip both with and without a Saliva Ejector (SE) in accordance with one embodiment of the present invention.

FIG. 4 shows a cross-sectional view of a High Volume Evacuation (HVE) tip in accordance with an alternative embodiment of the present invention.

FIGS. 5a and 5b show cross-sectional views of a High Volume Evacuation (HVE) tip in accordance with other alternative embodiments of the present invention.

FIGS. 6a-6c show cut-away views of a High Volume Evacuation (HVE) tip in accordance with other alternative embodiments of the present invention.

FIGS. 7a-7c show perspective and cross-sectional views of the cylindrically shaped filter assembly in accordance with one embodiment of the present invention.

FIGS. 8a-8c show perspective and cross-sectional views of the cylindrically shaped filter assembly in accordance with one embodiment of the present invention.

### DETAILED DESCRIPTION

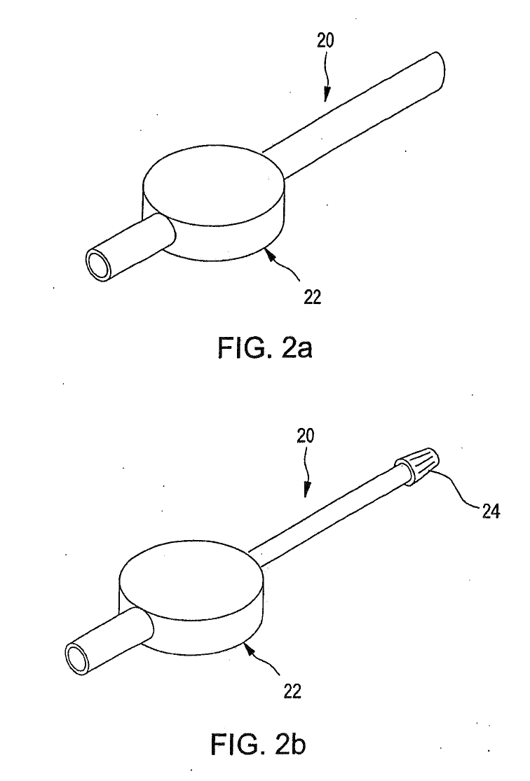

An apparatus to filter dental solid waste has been developed. FIGS. 2a and 2b shows perspective views of a High Volume Evacuation (HVE) tip 20 both with and without a Saliva Ejector (SE) 24 in accordance with one embodiment of the present invention. The tip of the HVE 20 has a filter 22 container that is integral to the body. The tip is then connected to the tube attached to the vacuum pump (not shown in FIG. 2). The device also is shown in FIG. 2a with a SE tip 24 that is optionally attached on the end. Typically, a new tip is used for each patient. This allows the tip with the container to be removed from the line after the procedure is completed. The used tip is then easily, cleanly, and safely disposed of in an appropriate manner

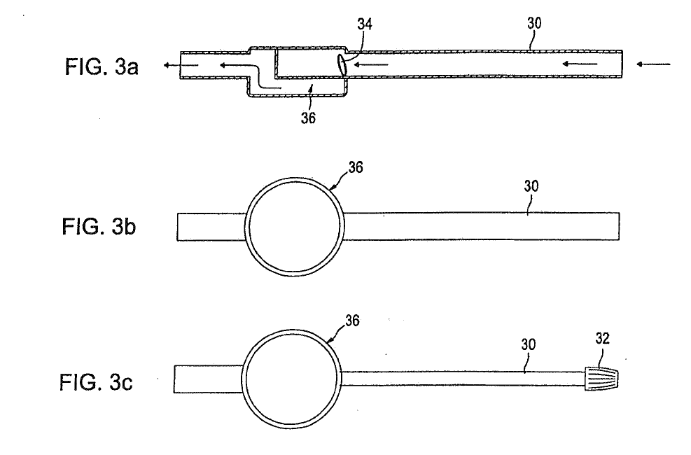

FIGS. 3a-3c show top and cross-sectional views of a High Volume Evacuation (HVE) tip 30 both with and without a Saliva Ejector (SE) 32 in accordance with one embodiment of the present invention. In this alternative embodiment, a flip valve or check valve 34 is include in the filter container 36 to prevent any backflow of filtered debris from returning to the patient's mouth.

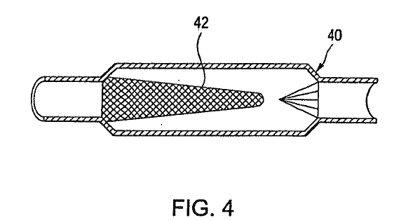

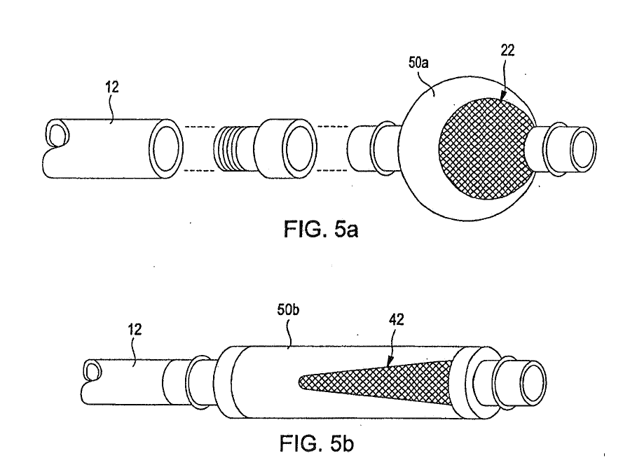

FIGS. 4 and 5 show views of other alternative embodiments of the present invention. FIG. 4 shows a cross sectional view a disposable HVE tip 40 with a conical shaped filter 42 that provides greater surface area for the filter. In other embodiments, the filter container may be a detachable cartridge that is removed from the tip for separate disposal. FIGS. 5a and 5b show cross sectional views of an example of detachable HVE filtration cartridges 50a and 50b.

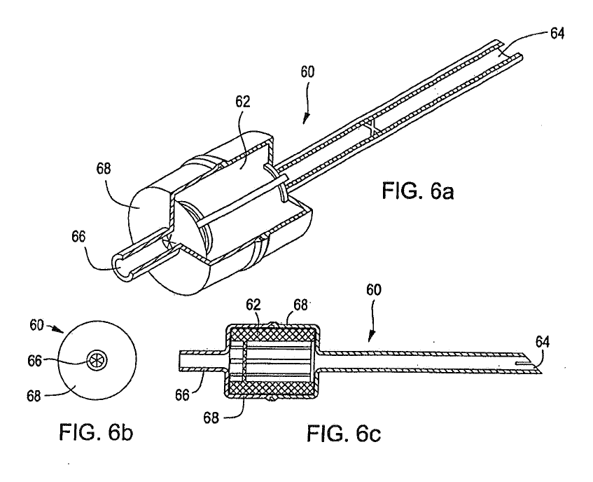

FIGS. 6a-6c show cut-away views of a High Volume Evacuation (HVE) tip 60 in accordance with other alternative embodiments of the present invention. In this embodiment, the filter 62 is completely contained within a disposable HVE tip 60. The suction end 64 of the tip is inserted into the patient's mouth. A saliva ejector (not shown) may be included if desired. The other end 66 of the tip is connected to the vacuum line (not shown) that provides suction for the invention. The filter 62 is entirely contained within the filter housing 68.

This embodiment of the invention is a disposable HVE tip with integrated filter. It is intended to be disposed after a single use. The HVE tip may include a check value to ensure retention of the dental waste within the device. The device is also flexible in the design of filters to be used. In some embodiments, the housing 68 may be opened to change a filter if needed. Other embodiments may use a sealed housing to prevent possible spillage of the filtered waste.

A conical shaped filter (as shown previously) or other suitable design may be inserted in the filter housing. However, any other suitable filter design may be used in any of the embodiments previously discussed. In some examples, the filter used in the invention should be able to capture debris greater than 30 microns in size. However, filters of different size may be used. If a filter designed to capture smaller debris (e.g., 5 microns and larger), the HVE tip may begin to lose effectiveness due to debris clogging the filter and resulting in a loss of suction. Features such as circular ridging, may be placed in the interior of the HVE tip before the filter to create a centrifugal action on the debris flow in order to dislodge any debris that gets stuck. Other features may be included to increase the effectiveness of the suction line be adding an “air venturi” to the HVE tip.

In contrast to previous statements, the filtration unit, in an alternative embodiment, is permanently sealed to allow the dental solid waste to be disposed of in a safe and environmentally friendly manner by reducing the chance of accidental exposure to the dental solid waste. In this embodiment, the permanently sealed filtration unit protects both the individual tasked with changing and/or disposing of the filtration unit as well as the environment. The permanently sealed filtration unit keeps the hazardous solid dental waste from contacting the individual or being released into the environment.

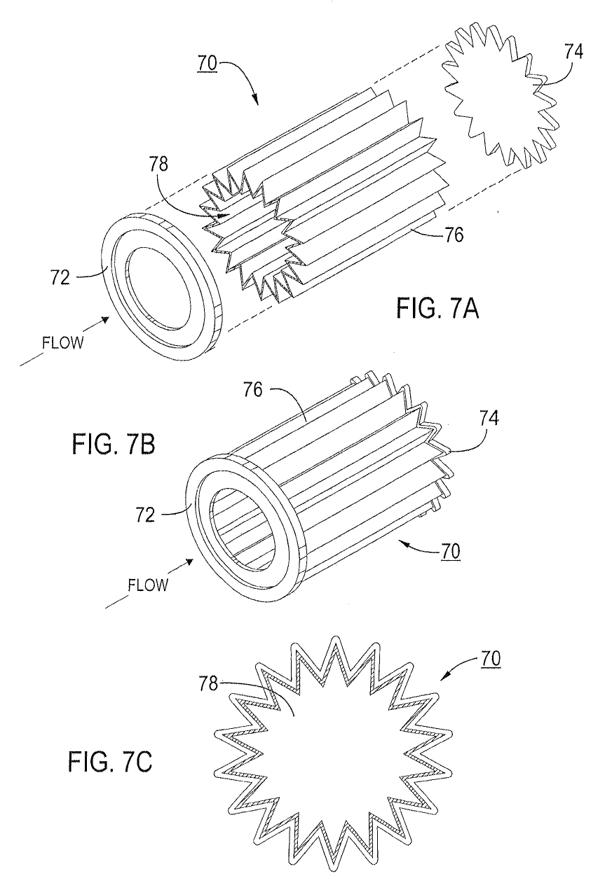

Another embodiment of the filtration unit is shown in FIGS. 7a-c. Generally, the filtration unit includes a filter assembly 70, inlet cap 72, a hollow portion 78 and an end cap 74. The filter assembly 70 has a plurality of folded pleats 76 to increase the surface area and efficiency of the filtration unit. In one embodiment, the filter assembly 70 contains eighteen (18) folded pleats 76 with equal surface area per section. In this embodiment, the filter assembly 70 may be made from UPS Class I materials, although any other filtration material approved for dental use is contemplated. In this embodiment the inlet cap 72 and end cap 74 may be made of ABS plastic. In this embodiment, the filter assembly 70 is designed to trap or “filter” solid dental waste greater than 10 microns.

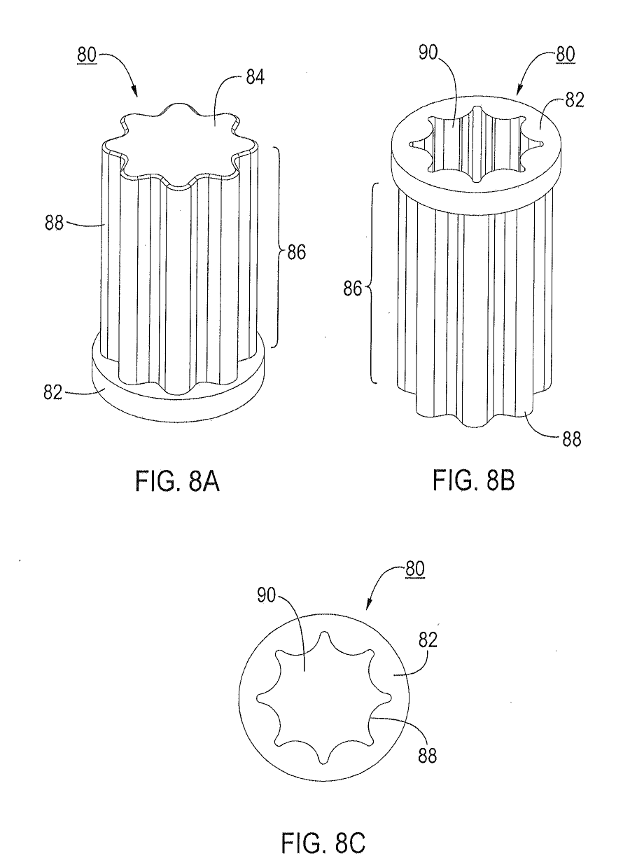

FIGS. 8a-8c show yet another embodiment of the filtration unit, in this embodiment the filtration unit 80 may be manufactured from one piece of USP Class 1 or ABS class 1 material (i.e., a single composition), although any other filtration material approved for dental use is contemplated. The filtration unit 80 includes a filter assembly 86, inlet cap 82, a hollow portion 90 and an end cap 84 all manufactured from a single piece of material. The filter assembly 86 has a plurality of folded pleats 88 to increase the surface area and efficiency of the filtration unit 80. In one embodiment, the filter assembly 86 contains eighteen (18) folded pleats 88 with equal surface area per section. In another embodiment, the filter assembly 86 contains eight (8) folded pleats 88 with equal surface area per section.

Notwithstanding previous statements, subsequent experimental results for this embodiment have shown that a filter assembly with a 5 micron pore size (i.e., retains solid dental waste larger than 5 microns) will function properly in the present invention. It is believed that the increased filter surface area achieved by including folded pleats (as shown in FIGS. 7a-7c) in the filter assembly allow for the smaller pore size. Accordingly, one embodiment of the present invention incorporates a filter, which may be either conical or cylindrical, with a 5 micron pore size.

Now referencing FIGS. 6a-c, in yet another embodiment, the suction end 64 is designed to receive or connect to a 0.4375 ( 7/16) inch tip which is inserted into the patient's mouth. In this embodiment, the other end 66 of the tip is designed to receive or connect to a 0.500 (½) or 0.625 (⅝) inch vacuum line (not shown).

The present invention has the advantages of providing a disposable, self- contained HVE tip that catches solid dental waste. The waste is collected at the source so the chance of contamination in the waste system is minimized. Each HVE tip completely contains the waste so that the change of spillage is also minimized. Additionally, the tip may be easily disposed after a single use. Further, costs may be reduced by using a conventional HVE non-filtration tip when there is no chance of contamination from solid waste. In on embodiment, the tip meets or exceeds the standards set forth in ISO 11143 published by the International Organization for Standardization.

The filtration units of the present disclosure also provide safe, efficient, economical and environmentally responsible for the separation, recovery and disposal of solid dental waste.

In one embodiment, the dental waste is “dental amalgam.” Dental amalgams are typically composed of 43% to 54% by weight of mercury and the remaining powder is made up of mainly silver (˜20-35%) and some tin, copper (˜10%), and zinc (˜2%). In an alternate embodiment, the dental waste is “prophy paste.” Prophy paste (also known as prophylaxis paste) is used by dental professionals during the routine cleaning of teeth.

The filtration units used in the method disclosed herein may be single patient use. “Single patient use” means that the filtration unit should be disposed of after use on a single patient and should not be re-used on a subsequent patient. In general, this conforms to the best practices as suggested by the American Dental Association. In an alternate embodiment, the filtration unit may be “single filtration use” such that once the filtration unit begins to lose functionality, it is disposed. In this embodiment, a filtration unit may be used on a certain number of patients or for a certain period of time on a single or multiple patients before being disposed. For example, in one embodiment, the filtration unit may be used for all patients seen in the dental office for a given day. When the operator notices that the filtration unit is losing functionality, the filter should be changed.

In one embodiment, the dental waste (such as amalgam) is removed from the patient's mouth by filtration using the one of the filters disclosed. After the filtration unit is used (i.e., either a single patient use filter or a single filtration use filter), it may be placed in a receptacle for storage and transport. The receptacle should meet or exceed all regulations and standards concerning the storage and shipment of dental waste. In one embodiment, the container complies with the ADA/American National Standards Institute Specification 109 regarding the Procedures for Storing Dental Amalgam Waste and Requirements for Amalgam Waste Containers for Storage/Shipment. After a container is filled with used filtration units, it is shipped to an approved rendering/recycling facility where the mercury and other heavy metals (if present) are removed from the solid dental waste. After shipment to a recycling center, the filters containing the dental waste are opened so that the dental waste may be removed. In one embodiment the filters and/or the housing surrounding the filters are “opened” so that the dental waste may be removed. The separation of the dental waste from the filter may be done automatically by machinery to minimize human contact with the dental waste. In alternate embodiments, the filtration units may opened by shredding or melting the plastic in the filtration units to access the dental waste to be removed. Other methods of opening the filtration units should be considered within the scope of this disclosure.

In summary, the advantages of the present invention include a self-contained filtration apparatus that is disposable and a filtration apparatus that minimizes contact with hazardous materials. The advantages of the present method are numerous. First, by trapping or filtering the dental waste before it entries the vacuum system's lines, the amount of dental waste containments that evade capture is likely reduced and the dental waste is not exposed to the harsh cleaning compounds necessary for cleaning the lines. This reduces the risk that the cleaning compounds will react with the dental waste and convert it to more harmful forms.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

I claim:

1. A method of filtering solid dental amalgam from the liquid waste removed from a dental patient's mouth, comprising:
a. removably connecting a high volume evacuator tip to a vacuum line, the tip comprising,
i. a first end reversibly connected to the vacuum line,
ii. a second end inserted into the patient's mouth, and
iii. a filtration unit located between the first and second ends, the filtration unit further comprising a permanently sealed filter assembly,
b. applying a vacuum to the tip,
c. suctioning the contents of the patient's mouth through the second end and into the filtration unit where the solid amalgam is captured by the filtration and removed from a liquid portion of the waste, the solid amalgam remaining in the filtration unit,
d. removing the tip from the vacuum line,
e. placing the tip into a disposal container,
f. storing the tip in the disposal container until the container is transported to a recovery facility,
g. removing the solid amalgam from the tip at the recovery facility, and
h. processing the solid amalgam to separate a mercury portion from the solid amalgam.

2. A method of separating solid dental waste from liquid dental waste, comprising:
a. capturing the solid dental waste in a permanently filtration unit while the liquid dental waste passes through the filtration unit,
b. transferring the filtration unit to a central storage container,
c. storing the central container until the central container is shipped to a handling facility, and
d. separating the solid dental waste from the filtration unit.

3. The method of claim 2 where the tip further comprises a saliva ejector.

4. The method of claim 2 where the solid dental waste comprises dental amalgam or a composite dental material.

5. The method of claim 2 where the solid dental waste comprises prophy paste.

6. The method of claim 2 where the filtration unit comprises a single patient use filtration unit.

7. The method of claim 2 where the filtration unit comprises a single filtration use unit.

8. The method of claim 2 where the filtration unit comprises a pore size from about five (5) to about twenty (20) microns.

9. The method of claim 7 where the pore size is about five (5) microns.

10. The method of claim 2 where the filtration unit further comprises a check valve.

11. The method of claim 10 where the filtration unit is of unitary construction.

12. The method of claim 12 where the tip is placed into a disposal container after removal from the vacuum line.

13. A method of separating solid dental waste from liquid dental waste, comprising:
a. reversibly connecting an evacuator tip comprising a filtration means to a vacuum line,
b. applying a vacuum to the vacuum line, and
c. capturing the solid dental waste in the filtration means.

14. The method of claim 15 where the tip further comprises a saliva ejector.

15. The method of claim 15 where the solid dental waste comprises dental amalgam.

16. The method of claim 15 where the filtration means comprises a single patient use filtration unit.

17. The method of claim 15 where the filtration means comprises a pore size from about five (5) to about twenty (20) microns.

18. The method of claim 15 further comprising:
a. storing the filtrating means in a storage container,
b. shipping the storage container to a recycling facility,
c. separating the solid dental waste from the filtration means, and
d. processing the solid dental waste to remove a metal.

19. A method of separating solid dental waste from liquid dental waste, comprising:
a. step for reversibly connecting an evacuator tip comprising a filtration unit to a vacuum line,
b. step for applying a vacuum to the vacuum line,
c. step for capturing the solid dental waste in the filtration unit,
d. step for transferring the filtration unit to a central storage container,
e. step for storing the central container until the central container is shipped to a handling facility, and
f. step for separating the solid dental waste from the filtration unit.
